(19) United States
(12) Patent Application Publication
(10) Pub. No.: US 2006/0092449 A1
(43) Pub. Date: May 4, 2006

(54) Printing device and printing method therefor

(76) Inventors: Ya-Han Chuang, Hsinchu City (TW); Te-Chuan Hsieh, Kaohsiung City (TW)

Correspondence Address: RABIN & Berdo, PC, 1101 14TH STREET, NW, SUITE 500, WASHINGTON, DC, 20005, US

(21) Appl. No.: 11/265,306

(22) Filed: Nov. 3, 2005

(30) Foreign Application Priority Data
Nov. 3, 2004 (TW) 93133450

(51) Int. Cl. G06F 3/12

(52) U.S. Cl. 358/1.13

(57) ABSTRACT

A printing device including a first memory unit, a second memory unit, a printing unit and a control unit is provided. The control unit is for receiving print data and then creating at least a print signal, and for controlling the printing unit to print the print data. The first memory unit and the second memory unit are for receiving and storing the print data from the control unit according to the print signal. The control unit transmits the print data to the first memory unit when the print signal does not comprise a manual print signal and to the second memory unit when the print signal comprises the manual print signal and controls the printing unit to automatically print the print data stored in the first memory unit and to manually print the print data stored in the second memory unit.

This application claims the benefit of Taiwan application Serial No. 93133450, filed Nov. 3, 2004, the subject matter of which is incorporated herein by reference.

### BACKGROUND OF THE INVENTION

1. Field of the Invention

The invention relates in general to a printing device and a printing method therefor, and more particularly to a printing device and the printing method therefor capable of prioritizing and printing the print data ready for automatic printing but storing the delayed print data in a memory unit temporarily.

2. Description of the Related Art

Living in today's society where science and technology advance rapidly, computer and its peripherals have become an essential part to modern people in their everyday lives. The peripherals of computer include scanners, printers, facsimile machines and multi-function peripheral (MFP). Take the printer for example, when a printer is electrically connected to a computer, the user can execute the printing of print data via the computer. Meanwhile, the computer will output a print signal and a print data corresponding to the print signal to the printer. The printer would print out the print data after receiving the print signal and the print data.

However, when the user would like to print the print data via the printer, the printer may proceed to a printing-suspended state due to paper out or other causes. For example, when the user sets the paper of the print data to be A4 sized, but the paper disposed in the paper tray of the printer turns out to be letter sized, the printer will enter a printing-suspended state. Furthermore, some printers will automatically contract then print the print data. If the user doest not want to have the print data be contracted, the user has to set the print data at manual printing. That is, the user has to go to the printer for manual printing in person. In case the user should forget to go to the printer for manual printing, the printer would proceed to the printing-suspended state. Once the printer proceeds to the printing-suspended state, the printer would not print the print data which would otherwise be printed automatically. Consequently, the printing efficiency of the printer is largely deteriorated, and the practicality of the printer is severely restrained. Moreover, the user has to manually process all of the print data that can not be printed under auto printing mode before the printer is resumed to auto printing mode and becomes able to automatically print the print data received onwards. This is indeed a big waste of time for the user.

### SUMMARY OF THE INVENTION

The invention to provide a printing device and a printing method therefor. According to the invention, the print data ready for automatic printing and the print data delayed in printing respectively are stored in two different memory units temporarily. Such a design increases the printing efficiency of the printing device. The print data ready for automatic printing is prioritized and printed, while the print data requiring user's manual operation is temporarily stored in a memory unit, lest the problem that the conventional printer might stop printing when the conventional printer receives the delay print data is generated. Consequently, the printing efficiency of the printer is largely increased, and the practicality of the printer is enhanced.

According to an object of the invention, a printing device including a printing unit, a control unit and a memory unit is provided. The printing unit is for printing print data. The control unit is electrically connected to the printing unit and is for receiving the print data and then creating a set of print signals according to the print data. The memory unit is electrically connected to the control unit and is for storing the print data. The control unit controls the printing unit to directly print out the print data when the set of print signals does not comprise a manual print signal, and stores the print data in the memory unit waiting for a further processing dependent on a user's selection when the set of print signals comprises a manual print signal.

According to another object of the invention, a printing device including a first memory unit, a second memory unit, a printing unit and a control unit is provided. The printing unit is for printing print data. The control unit is electrically connected to the printing unit for receiving the print data and then creating at least a print signal, and for controlling the printing unit to print the print data. The first memory unit and the second memory unit are electrically connected to the control unit, for receiving and storing the print data from the control unit according to the print signal. The control unit transmits the print data to the first memory unit when the print signal does not comprise a manual print signal and to the second memory unit when the print signal comprises the manual print signal and controls the printing unit to automatically print the print data stored in the first memory unit and to manually print the print data stored in the second memory unit.

According to other object of the invention, a printing method for a printing device is provided. At first, print data are received. Then, a set of print signals is created according to the print data. When the set of print signals does not comprise a manual print signal, the print data are printed out. When the set of print signals comprises a manual print signal, the print data are stored in a memory unit waiting for a further processing dependent on a user's selection.

According to other object of the invention, a printing method for a printing device is provided. At first, print data are received, and the control unit of the printer creates at least a print signal. Then, the print data is stored in a first memory unit and an auto-printing routine is proceeded when the print signal does not comprise a manual print signal. the print data is stored in a second memory unit and a first print-delay routine is proceeded when the print signal comprises the manual print signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a printing device according to a first embodiment of the invention;

FIG. 2 is a three-dimensional structural diagram of the printing device according to the first embodiment of the invention;

FIG. 3A is a flowchart of a printing method according to a second embodiment of the invention;

FIG. 3B is a flowchart of the auto-printing routine of FIG. 3A; and

FIG. 3C is a flowchart of the first print-delay routine of FIG. 3A and the second print-delay routine of FIG. 3B.

### DETAILED DESCRIPTION OF THE INVENTION

### First Embodiment

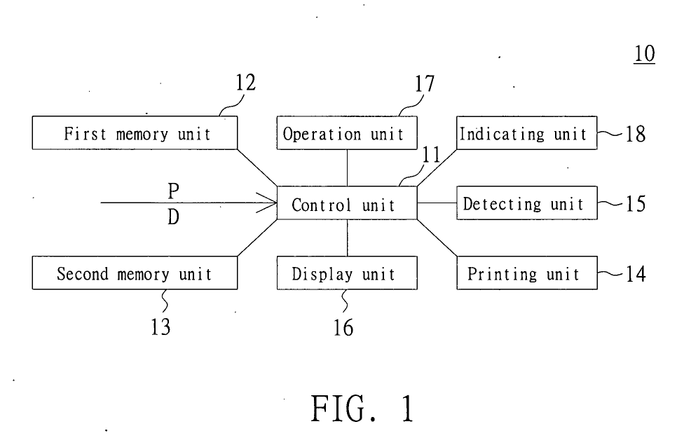

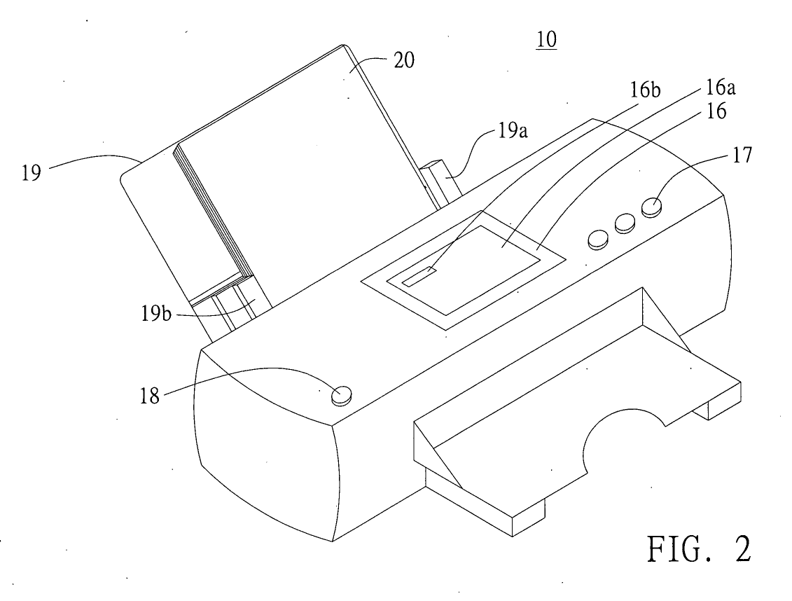

Referring to both FIG. 1 and FIG. 2, wherein FIG. 1 is a block diagram of a printing device according to a first embodiment of the invention, while FIG. 2 is a three-dimensional structural diagram of the printing device according to the first embodiment of the invention. In FIG. 1 and FIG. 2, the printing device 10 at least includes a control unit 11, a first memory unit 12, a second memory unit 13, a printing unit 14, a detecting unit 15, a display unit 16, an operation unit 17, an indicating unit 18 and at least a paper tray 19. The first memory unit 12, the second memory unit 13, the printing unit 14, the detecting unit 15, the display unit 16, the operation unit 17 and the indicating unit 18 are all electrically connected to or controlled by the control unit 11. The printing unit 14 is for printing print data D. The control unit 11 is electrically connected to the printing unit 14 for receiving the print data D, and then creating at least a print signal P according to the print data D, and for controlling the printing unit 14 to print the print data D. The first memory unit 12 and the second memory unit 13 are electrically connected to the control unit 11, for receiving and storing the print data D from the control unit 11 according to the print signal P. The control unit 11 transmits the print data D to the first memory unit 12 when the print signal P does not comprise a manual print signal and to the second memory unit 13 when the print signal P comprises the manual print signal and controls the printing unit 14 to automatically print the print data D stored in the first memory unit 12 and to manually print the print data D stored in the second memory unit 13.

The paper tray 19 is capable of accommodating at least a printing medium 20, such as paper. The detecting unit 15 is for detecting the status of the paper tray 19 and a page size of the printing medium 20. The control unit 11 detects, via the detecting unit 15, that whether the paper tray 19 has the printing medium 20. When the paper tray 19 is detected by the detecting unit 15 to have a printing medium 20, the control unit 11 can further detects, via the detecting unit 15, the paper size of the printing medium 20 accommodated in the paper tray 19. Besides, the paper tray 19 has two paper guiders 19a and 19b to retain the printing medium 20.

The print signal P and the print data D can be outputted from a computer or other electronic devices capable of outputting the print signal and the corresponding print data.

When the print signal P created by the control unit 11 does not comprise a manual print signal, the control unit 11 stores the print data D in the first memory unit 12.

When the print signal P created by the control unit 11 comprises the manual print signal, the control unit 11 stores the print data D in the second memory unit 13 so that the printing device 11 remains at a printing state.

In the present embodiment, the control unit 11 judges whether the print signal P comprises the manual signal to determine the print data D to store in the first memory unit 12 or the second memory unit 13.

Before the control unit 11 controls the printing unit 14 to print the print data D stored in the first memory unit 12, the control unit 11 judges whether the printing unit 14 is able to automatically print the print data D.

When the printing unit 14 is able to automatically print the print data D, the control unit 11 controls the printing unit 14 to print the print data D stored in the first memory unit 12.

When the printing unit 11 is unable to automatically print the print data D, the control unit 11 transfers the print data D stored in the first memory unit 12 to the second memory unit 13 so that the printing device 11 remains at the printing state.

When the control unit 11 stores the print data D in the second memory unit 12, the display unit 16 displays a print-delay list 16a. The print-delay list 16a has a print data option 16b corresponding to the print data D stored in the second memory unit 13. The display unit 16 can be a liquid crystal display (LCD) panel, an organic light emitting diode (OLED) panel, a plasma display panel (PDP) or an organic electroluminescent diode (OELD). In the present embodiment, the display unit 16 is exemplified by an LCD panel. The user can use the operation unit 17 to select the print data option 16b such as “delete option” or “print option” and so forth from the print-delay list 16a. The printing device 10 would print or delete the print data D stored in the second memory unit 13 according to the print data option 16b selected by the use. The operation unit 17 can be a key pad or a touch-control panel. In the present embodiment, the operation unit 17 is exemplified by a key pad. When the control unit 11 detects that the print-delay list 16a includes the print data option 16b, the control unit 11 controls the indicating unit 18 to emitting a light or a sound to indicate that the second memory unit stores the print data, and to remind the user that the printing device 10 still has the delayed print data D. The indicating unit 18 can be a flashing light, a light emitting diode (LED), a beeper or a speaker. In the present embodiment, the indicating unit 10 is exemplified by an LED.

The control unit 11 has a number of methods to judge whether the printing unit 14 is able to automatically print the print data D. These methods are elaborated below.

According to the first judging method, the control unit 11 detects, via the detecting unit 15, that whether the paper tray 19 accommodates the printing medium 20 to determine whether the printing unit 14 is able to automatically print the print data D onto the printing medium 20.

When the control unit 11 detects, via the detecting unit 15, that the paper tray 19 accommodates the printing medium 20, the control unit 11 controls the printing unit 14 to print the print data D stored in the first memory unit 12 onto the printing medium 20.

When the control unit 11 detects, via the detecting unit 15, that the paper tray 19 does not accommodate the printing medium 20, the control unit 11 transfers the print data D stored in the first memory unit 12 to the second memory unit 13.

According to the second judging method, the print signal P defines a paper size of the print data D and the control unit 11 detects the paper size of the printing medium 20 via the detecting unit 15. The control unit 11 judges whether the paper size of the printing medium 20 and that of the print data D are the same to determine whether the printing unit 14 is able to print the print data D sheet.

When the control unit 11 judges that the paper size of the printing medium 20 and that of the print data D are the same, the control unit 11 controls the printing unit 14 to print the print data D stored in the first memory unit 12 onto the printing medium 20.

When the control unit 11 judges that the paper size of the printing medium 20 and that of the print data D are the different, the control unit 11 transfers the print data D stored in the first memory unit 12 to the second memory unit 13.

According to the third judging method, when the user, who originally should select another paper tray (not shown in FIG. 2) having a paper as the default paper tray via the computer terminal, now selects the paper tray 19 as the default paper tray by mistake, the control unit 11 detects whether the paper tray 19 has the printing medium 20 via the detecting unit 15 to determine whether the printing unit 14 is able to automatically print the print data D.

When the control unit 11 detects that the paper tray 19 has the printing medium 20 via the detecting unit 15, the control unit 11 controls the printing unit 14 to print the print data D stored in the first memory unit 12 onto the printing medium 20.

When the control unit 11 detects that the paper tray 19 doesn't have the printing medium 20 or any paper via the detecting unit 15, the control unit 11 transfers the print data D stored in the first memory unit 12 to the second memory unit 13.

However, anyone skilled in the scope of technology of the present embodiment of the invention would understand that the first memory unit 12 and the second memory unit 12 can be a memory or a hard disc, and the control unit 11 can be a microprocessor (μP) or an application specific integrated circuit (ASIC). Besides, the display unit 16 and the operation unit 17 can be incorporated in a touch-control display panel. The printing device 10 can be a scanner, a printer, a facsimile machine, a multi-function machine, or a printing device at any node of the Internet.

When the print data D are received by the control unit 11, no matter the print data D are set as the manual printing or the non-manual printing, the design of storing the delayed print data in the second memory unit 13 enables the printing device 10 to remain at the printing state all the time. Consequently, whenever each set of the print signal and the print data corresponding to the print signal is received by the control unit 11, the control unit 11 can determine whether to automatically print or delay the print data according to the attribute of the print signal or whether the printing unit 14 is able to automatically print the print data. Consequently, the problem that the conventional printer might stop printing when the conventional printer receives the delay print data can be avoided.

Before the print data stored in the first memory unit 12 are printed sequentially, if a document has to go for manual printing due to paper out or erroneous settings of the printing device 10 or other factors, then the printing device 10 would automatically transfer the print data to the second memory unit 13 but print the other print data ready for auto printing. As for the delayed print data still not ready for auto printing remains to be stored in the second memory unit 13. Meanwhile, the indicating unit 18 would use a flashing light or other methods to inform the user that there is a print data requiring manual processing. After all of the print data ready for automatically printing are already printed out, the user would be able to process the delayed print data according to manual printing. The display unit 16 would display a message instruction to inform the user how to process the delayed print data. Consequently, all of the print data ready for automatically printing are printed out except the print-delay documents, largely increasing the printing efficiency of the printing device 10.

### Second Embodiment

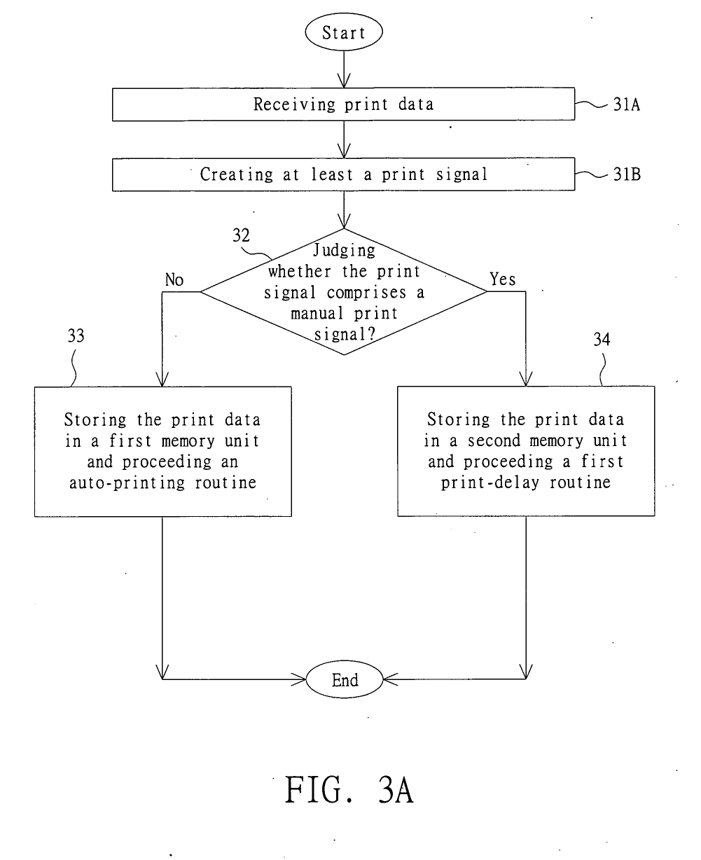

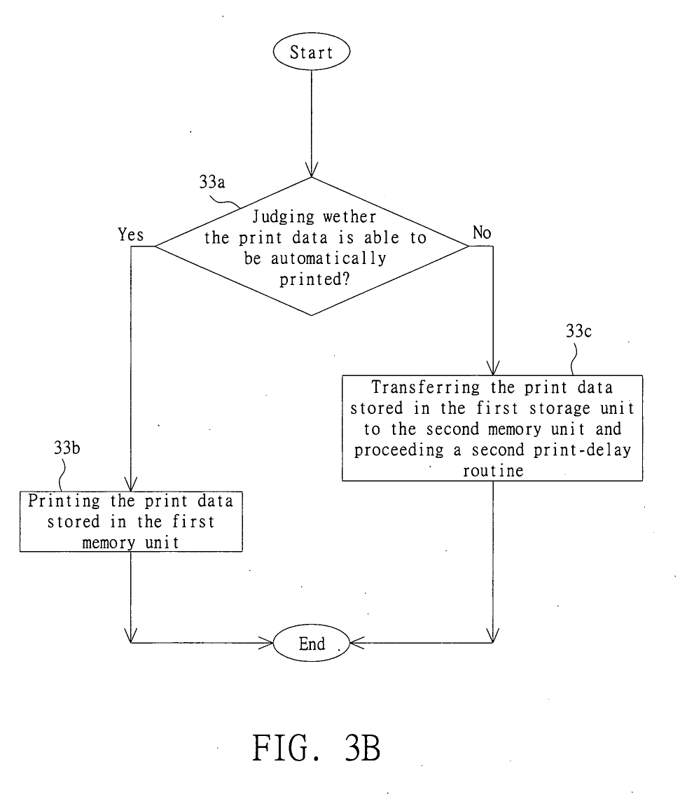

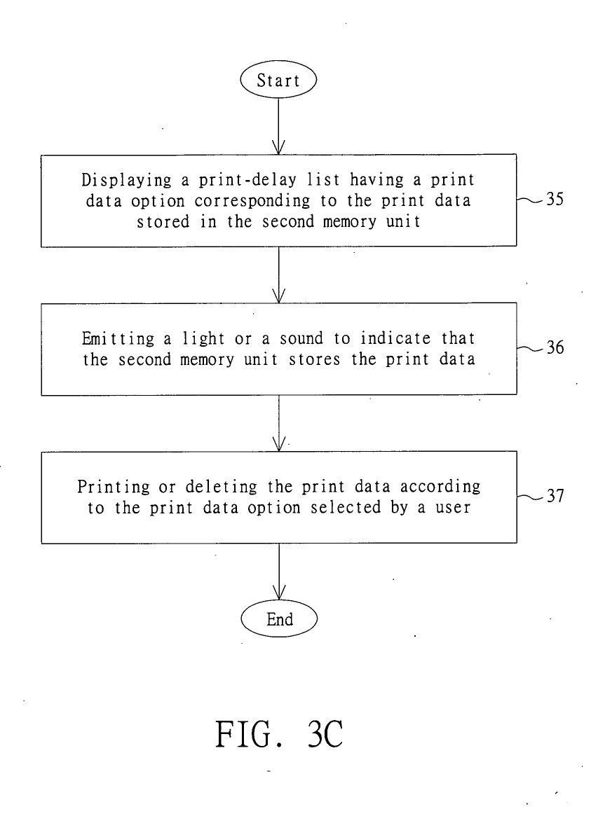

Referring to FIG. 3A, a flowchart of a printing method according to a second embodiment of the invention is shown. The printing method is applied to the printing device 10. Referring to both FIG. 1 and FIG. 2. The printing method begins at step 31A, print data D are received, and at set 31B the control unit of the printer creates at least a print signal P. Then, proceed to step 32, whether the print signal P comprises a manual print signal is judged. When the print signal P does not comprise the manual print signal, step 33 is proceeded. In the setp33, the print data D is stored in a first memory unit 12 and an auto-printing routine is proceeded. When the print signal P comprises the manual print signal, step 34 is proceeded. In step 34, the print data D is stored in a second memory unit 13 and a first print-delay routine is proceeded. In the present embodiment, the printing method can skip step 32 and judge whether the print signal P comprises the manual print signal to determine the print data D is processed in step 33 or step 34.

The above auto-printing routine is shown in FIG. 3B. At first, the routine begins at step 33a, whether the print data D is able to be automatically printed is judged before printing the print data D stored in the first memory unit 12. When the print data D is judged to be able to be automatically printed, step 33b is proceeded. In the step 33b, the print data D stored in the first memory unit 12 is printed and an auto-printing routine is proceeded. When the print data D is judged to be unable to be automatically printed, step 33c is proceeded. In the step 33c, the print data D stored in the first memory unit 12 is transferred to the second memory unit 13, and a second print-delay routine is proceeded.

According to the present embodiment, a number of judging methods are applicable to step 33a. The judging methods are elaborated below. In the first judging method, whether the paper tray 19 accommodates the printing medium 20 is detected to determine whether the print data D is able to be automatically printed. When the printing medium 20 is detected, step 33b is proceeded. In step 33b, the print data D stored in the first memory unit 12 is printed. When the printing medium 20 is not detected, step 33c is proceeded. In step 33c, the print data D stored in the first memory unit 12 is transferred to the second memory unit 13, and the second print-delay routine is proceeded.

In the second judging method, whether the paper size of the printing medium 20 and that of the print data D are the same is judged to determine whether the print data D is be able to be automatically printed. When the paper size of the printing medium 20 and that of the print data D are judged to be the same, 33b is proceeded. In step 33b, the print data D stored in the first memory unit 12 is printed onto the printing medium 20. When the paper size of the printing medium 20 and that of the print data D are judged to be different, step 33c is proceeded. In step 33c, the print data D stored in the first memory unit 12 is transferred to the second memory unit 13, and the second print-delay routine is proceeded.

Besides, the first print-delay routine is the same with the second print-delay routine as shown in FIG. 3C. At first, in step 35, a print-delay list 16a is displayed. The print-delay list 16a has a print data option 16b corresponding to the print data D stored in the second memory unit 13. Next, proceed to step 36, a light or a sound is emitted to indicate that the second memory unit stores the print data and to remind the user that the print-delay list 16a has the print data option 16b corresponding to the print data D still requires the user's manual operation. Next, proceed to step 37, the user uses the operation unit 17 to select the print data option 16b such as “delete option” or “print option” and so forth from the print-delay list 16a. The printing device 10 would print or delete the print data D according to the print data option 16b selected by the user.

According to the printing device and the printing method disclosed in above embodiment of the invention, the print data ready for automatic printing and the print data delayed for printing respectively are stored in two different memory units temporarily. Such design increases the printing efficiency of the printing device. The print data ready for automatic printing is prioritized and printed, while the print data requiring the user's manual operation is temporarily stored in a memory unit, lest the problem that the conventional printer might stop printing when the conventional printer receives the delay print data is generated. Consequently, the printing efficiency of the printer is largely increased, and the practicality of the printer is enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A printing device, comprising:
a printing unit for printing print data;
a control unit, electrically connected to the printing unit, for receiving the print data and then creating a set of print signals according to the print data; and
a memory unit, electrically connected to the control unit, for storing the print data;
wherein the control unit controls the printing unit to directly print out the print data when the set of print signals does not comprise a manual print signal, and stores the print data in the memory unit waiting for a further processing dependent on a user's selection when the set of print signals comprises a manual print signal.

2. The printing device according to claim 1, wherein the printing unit comprises a paper tray capable of accommodating a printing medium, and a detecting unit connected to the control unit for detecting the status of the paper tray and a page size of the printing medium.

3. A printing method for a printing device, comprising:
receiving print data;
creating a set of print signals according to the print data;
when the set of print signals does not comprise a manual print signal, printing out the print data; and
when the set of print signals comprises a manual print signal, storing the print data in a memory unit waiting for a further processing dependent on a user's selection.
